(19) United States
(12) Patent Application Publication
(10) Pub. No.: US 2010/0293162 A1
(43) Pub. Date: Nov. 18, 2010

(54) Automated Keyword Generation Method for Searching a Database

(75) Inventors: David E. Odland, Scottsdale, AZ (US); Kathryn P. Odland, Scottsdale, AZ (US); Justin Seth Kniep, Chandler, AZ (US); Angela Christina Stigen, Mesa, AZ (US); Zheng Rong, Phoenix, AZ (US); Jan Maurice Allen, Tempe, AZ (US)

Correspondence Address: Global Patent Solutions, LLC, 1375 N. Scottsdale Rd.,, Suite 330, Scottsdale, AZ, 85257, US

(73) Assignee: GLOBAL PATENT SOLUTIONS, Scottsdale, AZ (US)

(21) Appl. No.: 12/466,949

(22) Filed: May 15, 2009

(51) Int. Cl. G06F 17/30

(52) U.S. Cl. 707/736; 704/9; 707/759; 707/769; 707/805

(57) ABSTRACT

The present invention relates to a method of generating keywords in an automated manner for use in searching an electronic database. The generated groups of keywords may be formatted in a variety of configurations, including a table. The table may include a plurality of columns for keywords and a plurality of rows for groups of keywords. The plurality of columns may include categories for keywords, and keywords with software compatible operators. A user may input at least one keyword in the table and is presented, in an automated manner, with at least one suggestion of a related term from which the user may choose. The sources of suggestions may include commercial thesauri or dictionaries, or a database of previously executed search queries or saved keyword tables. Boolean operators compatible with the database to be searched are added in an automated manner to the selected keywords when the table is populated.

### FIELD OF THE INVENTION

The present invention relates generally to keyword searching a database and, more particularly, to an automated method for generating a set or group of keywords for searching a database.

### BACKGROUND OF THE INVENTION

Computerized database searching in general has become a valuable skill in the age of electronic databases, the Internet and the World Wide Web. With databases stored in an electronic format and accessible through the Internet and the World Wide Web, researchers are able to search for documents by keyword. A researcher's proficiency in searching databases usually develops over time through a trial and error process. Over time the researcher gains knowledge of a variety of skills, such as which Boolean operators are best for returning a desired result, which keywords return the desired result, which keywords are common enough to return undesired results, and at what length to truncate a keyword.

A relatively inexperienced researcher may be able to improve his searching skills quicker if knowledge from a more experienced researcher or from a commercial source is communicated. If a relatively inexperienced researcher started with some of the accumulated knowledge of past searches, the researcher might be able to conduct a more efficient search of the database. Efficiency is essential to the field of research, as a researcher may be billing by the hour or the utilized database may charge for each search query submitted. Consequently, it would be advantageous for a researcher to start with a collection of base knowledge including keywords, synonyms, and truncations for a specific technical field to be searched. Unfortunately, such a collection of base knowledge for various technical fields is not known to be currently available.

One example of a field that highly values the skill of database searching is intellectual property research. In intellectual property research, a search is often conducted utilizing keywords within electronically searchable websites, databases of patent documents, databases of journal articles and other literature. Searching with keywords commonly can be a challenge in intellectual property research due to the fact that different art/technology areas often utilize a specific vocabulary of words with definitions differing from the common language definition. Additionally, intellectual property documents in the same art/technology area but from different countries may use different spellings when referring to the same word (e.g., airplane and aeroplane). Over time industries also develop acronyms for common word phrases which may not be obvious to one outside of the art/technology area or industry.

A researcher in the intellectual property field could benefit greatly from accumulated knowledge found in previously executed searches on related search subjects. Within these previously executed searches the researcher could find such items as synonyms, acronyms, common misspellings, foreign spellings, suggested truncations, as well as other terms that would not necessarily be found by looking up the search subject in a commercially available dictionary or thesaurus. Presently, there is not an efficient method available for accessing the knowledge of prior searches and keywords with truncations ready to be used in a search engine or database. The known available methods to address this problem provide only a partial solution. Some prior art methods make suggestions based on commercially available sources, but these methods may not account for the fact that inventors may use any words they choose to describe their invention, and that inventors may use obscure choices of words or may misspell the terms. Some current methods also allow the researcher to select from a categorized word list, but these methods lack efficiency if the researcher has to obtain words from multiple words lists. Other known methods allow the researcher to access previous search queries in their entirety, but this method also lacks efficiency if the searcher must retrieve keywords individually from multiple search queries or search strategies.

As can be seen, there is a need for an easily accessible and usable aggregation of knowledge, such as keywords and truncations, from previous searches which may provide the following benefits, such as savings of both money and time, as well as increased quality of the search results. Furthermore, there is a need for a method that enables keyword searching a database to be more efficient by reducing the preparation time for a search and increasing the likelihood of using keywords that will return the best results, which can equate to saved money or time.

The present invention addresses the identified needs by populating a set, group or table in an automated manner with suggestions for terms related to relevant keywords already known to the researcher, and efficient truncations for the known and suggested terms from a database of previously stored search queries or keyword tables, and commercially available sources.

### SUMMARY OF THE INVENTION

It is a principal object of the present invention to provide a method of generating keywords in an automated manner for use in searching an electronic database. The generated groups of keywords may be formatted in a variety of configurations, such as but not limited to tables, lists, maps, and trees. For Example, a group in the embodiment of a table may include a plurality of columns for keywords and a plurality of rows for groups of keywords. The categories for the plurality of columns may include, but is not limited to, First Tier keywords, Second Tier keywords, Acronyms, Case Sensitive keywords and keywords with software compatible operators. A user may input at least one keyword in the table and may be presented, in an automated manner, with at least one suggestion of a related term from which the user may choose. The suggestions may include, but are not limited to, common language synonyms, art-specific synonyms, common misspellings, foreign spellings, acronyms, acronym expansions or abbreviations. The suggestions may come from sources including, but not limited to, commercially available thesauri or dictionaries, a database of previously executed search queries, a database of saved keyword tables, or a database of art-specific keywords that was developed by art/technology experts in a particular field.

Boolean operators compatible with the database to be searched may be added in an automated manner to the selected keywords when the table is populated. The addition of the Boolean operators includes, but is not limited to, reducing a keyword to a root form and adding a truncation operator identifying the number of characters to follow the root word in order to encompass variations of the word, adding proximity operators for keywords that consist of a phrase or multiple terms, adding an operator to indicate the keyword is case sensitive, adding an operator to indicate the part of speech of the keyword, adding an operator to indicate that only one of the terms in a group needs to be present, adding an operator to indicate that all of the terms in a group need to be present, or any other known Boolean operators. The user may modify the keywords in the populated table. Modifications may include, but are not limited to, inputting additional keywords, modifying the Boolean operators, modifying the position at which a keyword is truncated, or any other modifications desired by the user. The groups of related terms may be input into the search query field manually by the user, or in the alternative the table may be linked to an electronic database or search engine through electronic communication and input the groups of related terms in the search query field of an electronic database or search engine without any additional action by the user. The features, functions, and advantages can be achieved independently in various embodiments of the present invention or may be combined in yet other embodiments.

### BRIEF DESCRIPTION OF THE DRAWINGS

The object, features and advantages of the present invention will become more apparent by describing the preferred embodiments with reference to the accompanying figures, in which:

FIG. 1 is a flow diagram outlining the operations performed by a method for generating a keyword group for searching an electronic database in accordance with an embodiment of the present invention;

FIG. 2 is an exemplary automated keyword table in accordance with another embodiment of the present invention; and

FIG. 3 is an exemplary column containing keywords and software compatible operators of the keyword table illustrated in FIG. 2.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

### 1. Definitions

The following terms are used throughout the disclosure as defined below:

Electronic Database—a structured collection of data and associated information, including but not limited to full text patent documents, literature, webpages or other collections of text, that is stored in a computer system or other computer readable memory where the data can be stored, queried, and retrieved.

Additional Action by the User—copying and pasting, or other known methods of manually retrieving, inputting or outputting information including but not limited to methods that require steps of formatting the retrieved information.

Keyword—a single term, a group of terms, or a phrase relevant to research.

Art Specific Synonym—a keyword that is part of a vocabulary, lexicon, or jargon for a specific art area, field, or industry that has a specialized meaning within that art area, field or industry.

### 2. Automated Keyword Method

One exemplary embodiment of the present invention describes a method of generating a keyword group. In one exemplary embodiment the group can be a table, wherein the populated keyword table provides a resource for a user to construct queries with the keywords to search within an electronic database. Generally, the table will both generate suggestions of related terms for keywords entered by the user and add Boolean operators to the groups of related terms in an automated manner which requires no additional action by the user. With a completed table, the user can use groups of related terms with Boolean operators directly from the table within the search query field of an electronic database or search engine. The groups of related terms may be input into the search query field manually by the user, or in the alternative the table may be linked to an electronic database or search engine through electronic communication and input the groups of related terms in the search query field of an electronic database or search engine without any additional action by the user.

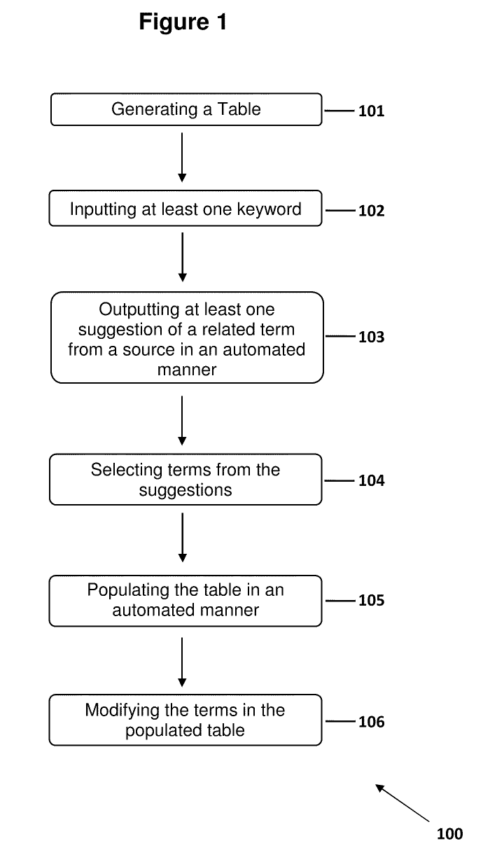

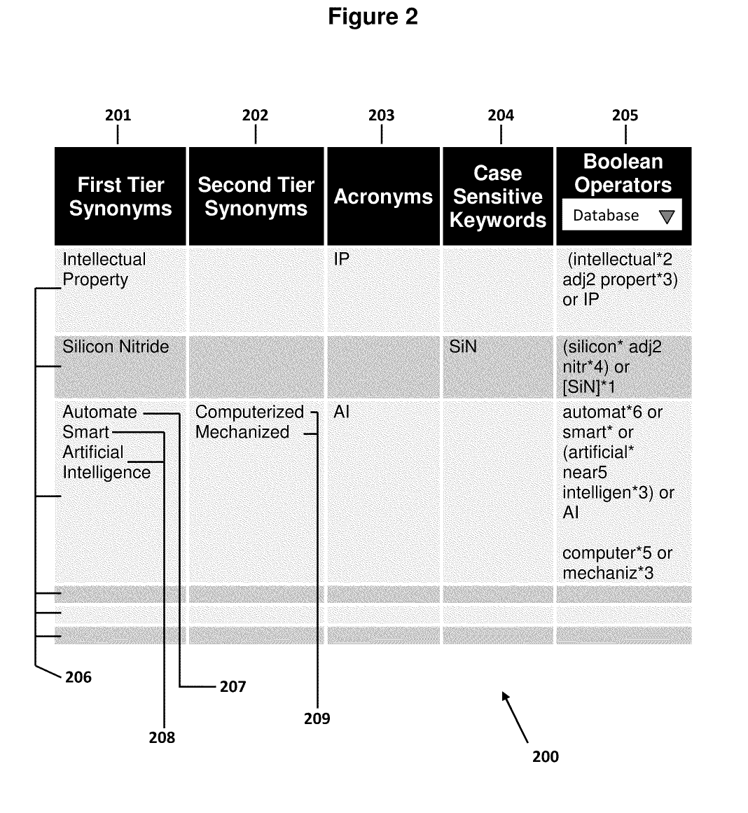

Referring to FIG. 1, a flow diagram for representing a method 100 for generating a keyword table 200 (as illustrated in FIG. 2) for searching an electronic database is shown. As illustrated in the flow diagram of FIG. 1, a first step 101 in the method 100 is generating a table, such as table 200 shown in FIG. 2. The table may contain at least one column for keywords, and preferably contains a plurality of columns each utilized for a different category of keywords. The table may also contain at least one row for keywords, and preferably contains a plurality of rows each utilized for a separate group of keywords. The columns for different categories of keywords may include, but are not limited to, first tier keywords, second tier keywords, acronyms, case sensitive keywords, and keywords with software compatible Boolean operators.

An exemplary keyword table 200 is illustrated in FIG. 2. The keywords in the First Tier Synonyms column 201 may be the keywords most specific to the subject that is being searched. These keywords may be determined by the user to be the keywords that will most likely return the desired results when used in a search query. The first column 201 contains keywords and their associated First Tier Synonyms wherein, for example, each row 206 of the first column 201 contains a keyword 207 in a top position that may be followed by First Tier Synonym keywords 208.

The keywords found in the Second Tier Synonym column 202 will be more peripheral in relation to the subject that is being searched. Keywords in the Second Tier Synonym column 202 will also be more general than the keywords in the First Tier column 201, and may be more likely to return broader results when used in a search query. The second column 202 contains Second Tier Synonym keywords 209 wherein each row 206 of the second column 202 contains a keyword or keywords that correspond to the First Tier keyword 207 in that same row. The table 200 however is not limited to two tiers of relevance for the keywords. If the user desires, the columns 201 and 202 may continue with additional columns of relevance (not shown), such as Third Tier, Fourth Tier, etc., to the extent that the user wants to classify the keywords as to their relevance to the search subject.

Sill referring to FIG. 2, the keywords in the Acronyms column 203 may be keywords or synonyms to the keywords where the individual letters of the term represent words and may be expanded into a phrase using the represented words. The expansion of the acronym may appear in the keyword columns 201 and 202 that classify the keywords by relevance, such as First Tier, Second Tier, etc. An example of a keyword that would be used in the Acronym column 203 is ‘IP’. The term ‘IP’ can also be expanded out into ‘Intellectual Property’, as shown in the First Tier Column 201. For an electronic database search where the keyword ‘Intellectual Property’ has some relevance, the keyword ‘IP’ would appear in the Acronyms column 203 and the keyword ‘Intellectual Property’ would appear in the appropriate relevance column, such as First Tier column 201, Second Tier column 202, etc.

Case Sensitive column 204 may contain keywords that are relevant to the search only when the letters are in a specific casing. One area in which case sensitive keywords are common is within the chemical compositions field. In the chemical compositions field, a composition of elements may coincidentally spell a common English word that has an unrelated meaning. One example of this occurrence is evident when the search subject is ‘silicon nitride films’. The composition for silicon nitride can be written as ‘SiN’. The letters s, i, and n also spell the common English word ‘sin’, which has a meaning unrelated to silicon nitride. The problem that arises when using the keyword ‘SiN’ in a case insensitive search is the search engine will return results that include the keywords ‘sin’, ‘SIN’, or ‘Sin’. When the search subject is silicon nitride films the user will only want results that include the specific casing of keyword ‘SiN’ and not ‘sin’, ‘SIN’ or ‘Sin’.

Also, if a Boolean/truncation operator, such as ‘*’, is used with ‘SiN’ to include other variations of the composition such as ‘SiN₂’, then the keyword may be typed as ‘SiN*’. In a case insensitive search the search engine will return results that include keywords such as ‘sine’, ‘sing’, ‘sink’, etc., that are unrelated to ‘SiN₂’. The keywords in the Case Sensitive column may be keywords for which the user wishes to exclude results that contain the keyword in any other casing besides the specific casing in which the keyword is input into the table.

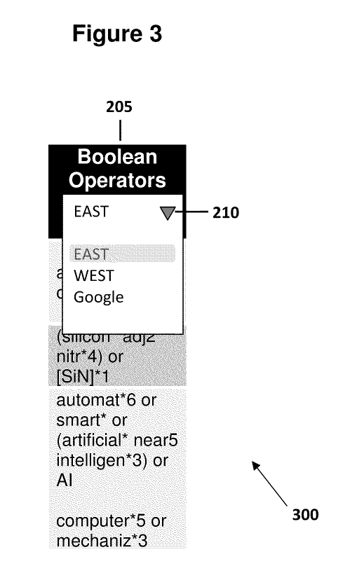

As illustrated in FIG. 2, the column 205 containing software compatible operators may contain a combination of the keywords from any of the other columns of the table along with the software compatible operators. The software compatible operators include, but are not limited to, Boolean operators indicating: truncation/the number of characters to follow a term (such as *, *n, ?, * * * , etc.), the case sensitive nature of the term, the proximity of terms to other terms (such as adj, near, with, same, w/, etc.), the part of speech of the term, all terms must be present (such as AND, etc.), or only one term must be present (such as OR, etc.). Any of the software compatible operators can be used individually or in combination with other software compatible operators for that specific database. Electronic databases often utilize Boolean operators that may be specific to that database that may not be compatible with another database. In one embodiment of the present invention the user will have the option to choose which set of Boolean operators will be used by selecting a corresponding database, which uses those Boolean operators, by any known selection means, such as, but not limited to, a pull down menu 210 listing a plurality of databases, as illustrated in FIG. 3. By providing the pull down menu 210, the user may be given the option to select whether a new column for keywords with software compatible operators will be generated for each database selected or whether a single column will be re-populated when the database selection is changed.

While the disclosure above describes the table, as illustrated in FIG. 2, with category headings across the top of the columns and groups of keywords contained in the rows, it would be obvious to one of ordinary skill in the art to achieve the same objective by keeping the substance of table but changing the configuration, orientation or format. Such alternative embodiments providing the same function may include, but are not limited to, a table with category headings across either sides of the rows and groups of keywords contained in columns, a table with category headings across the bottom of the columns and groups of keywords contained in the rows, lists containing categorized groups of keywords, tree diagrams containing categorized groups of keywords, word maps containing categorized groups of keywords, three dimensional representations of categorized groups of keywords, etc.

Referring again to FIG. 1, a second step 102 in the method 100 may involve inputting at least one keyword in a column of the table (such as columns 201, 202, 203, or 204 of table 200, as shown in FIG. 2). The user may input a keyword relevant to the search subject in any column of the table by any known input means, including but not limited to, typing the keyword, pasting the keyword, or highlighting/selecting the keyword in an electronic document which is in electronic communication with the keyword table.

A third step 103 in the method 100 may involve outputting at least one suggestion of a related term for the at least one keyword input. The at least one suggestion of a related term will be presented to the user in an automated manner without any additional action by the user. The at least one suggestion of a related term may include, but is not limited to, common language synonyms, art specific synonyms, common misspellings, foreign spellings, acronyms, and acronym expansions or abbreviations. The at least one suggestion of a related term can be used to populate the other columns of the table or the same column in which the keyword was input (such as columns 201, 202, 203, or 204 of table 200, as shown in FIG. 2).

The at least one suggestion of a related term may come from multiple types of sources. One type of source may be commercially available dictionaries or thesauri. Another type of source may be a database specific to a user or shared by a plurality of users which contains previously executed search queries or saved keyword tables. By using a database of previously executed search queries or saved keyword groups/tables a user can receive the benefit of the aggregated knowledge of past searches on related subjects. The database of previously executed search queries or saved keyword tables can fill in the gaps left by the commercially available sources with art specific synonyms, common misspellings, foreign spellings and efficient keyword truncations that were found to be useful in prior searches of a related subject.

The source of suggestions may also contain the ability to learn from keyword groups or tables that are constructed by users to continually improve the suggestions. A database of previously executed search queries or saved keyword groups or tables will track, analyze, and store the combinations of keywords that are grouped together and the relationships between the groups of keywords. Through the analysis of keyword groups in a table (such as table 200, as illustrated in FIG. 2), the database will learn how the user grouped various keywords together, such as but not limited to, First and Second Tier Synonyms, Acronyms and acronym expansions in the First and Second Synonyms, truncations of First and Second Tier Synonyms, etc., and store these keyword groups and relationships. This analysis will allow the system to improve the suggestions provided through manners such as, but not limited to, increasing the number of related keyword suggestions for a specific keyword, adding more art specific suggestions to the source for a specific keyword, increasing the accuracy of placing suggestions in a Tier of relevance for a group of keywords, suggesting common truncation lengths for keywords, reducing the number of keyword suggestions, etc.

Still referring to FIG. 1, a fourth step 104 in the method 100 may provide the user with means to select which, if any, of the at least one suggestions of related terms to include in the group or table. The means of selecting a suggested, related term may be any known means of selecting items on a computer or an electronic interface, such as but not limited to using a computer mouse pointer to click on or next to the suggested terms, using vocal commands, pressing an assigned key on a keyboard or keypad, or pressing a touch screen. The user may also select all or select none of the suggestions. With this option the user may exercise discrimination in which suggestions are included through a positive action or addition of keywords. If the user decides to not include any of the suggestions, the user may proceed to another action, such as inputting another keyword, without selecting any of the output suggestions.

Alternatively, the group or table may automatically populate with the output suggestions without any additional action by the user, and the user may be enabled to remove suggested keywords not applicable or those the user does not wish to include through known selection means. The known selection means may include but are not limited to using a computer mouse pointer to click on or next to the suggested terms, using vocal commands, pressing an assigned key on a keyboard or keypad, or pressing a touch screen. This alternative option allows the user to exercise discrimination in which suggestions are included through a negative action or subtraction of keywords, including the removal of all suggested keywords.

The fifth step 105 in the method 100 may involve populating the group or table in an automated manner without any additional action by the user. In the table embodiment, the columns of the table (such as columns 201, 202, 203, 204, or 205 of table 200, as shown in FIG. 2) will be populated with the terms selected by the user, including the column for keywords with software compatible operators (such as column 205 of table 200, as shown in FIG. 2). The column for keywords with software compatible operators will be populated in an automated manner without any additional action by the user using the keywords from any of the other columns of the table (such as columns 201, 202, 203, or 204, of table 200, as shown in FIG. 2), and the Boolean operators for the database selected by the user (for example, by utilizing the pull down menu 210, as illustrated in FIG. 3).

The addition of Boolean operators includes, but is not limited to: reducing a keyword to a root form and adding a truncation operator identifying the number of characters to follow the root word in order to encompass variations of the word (e.g., the keyword ‘rotate’ could be populated in the column as ‘rotat*4’ to encompass variations such as rotating, rotation, rotations, rotatable, rotatably, etc.), adding proximity operators for keywords that consist of a phrase or multiple terms (e.g., the keyword ‘Intellectual Property’ could be populated as ‘intellectual adj property’, ‘intellectual near3 property’, ‘intellect* with propert*’, etc.), adding an operator to indicate the keyword is case sensitive, adding an operator to indicate the part of speech of the keyword, adding an operator to indicate that only one of the terms in a group needs to be present (e.g., ‘apple OR fruit’, etc.), adding an operator to indicate that all of the terms in a group need to be present (e.g., ‘apple AND fruit’, etc.), any combination thereof or any other Boolean operator discussed above, known to a skilled artisan or database specific. When populating the column for keywords with software compatible operators, the default for the root form of the keyword and truncation operator indicating the number of characters to follow may come from the sources that include previously executed search queries or saved keyword groups or tables. In addition, when an operator is added to indicate the part of speech, this allows the user to limit the keyword to particular English uses of the keyword (i.e., nouns, adjectives, verbs, etc.). For instance, the user may want to limit the results of a search string to having the keyword ‘map’ in the form of a noun (e.g., geographical maps) rather than the form of a verb (e.g., mapping coordinates). Thus, in this example truncating the keyword as ‘map*’ and further limiting by the part of speech being nouns, would only return maps and not the act of mapping.

The sixth step 106 in the method 100 may provide the user with the chance to modify any of the keywords once the group table is populated. Modifications may include, but are not limited to, inputting/deleting additional keywords, modifying the Boolean operators, modifying the position at which a keyword is truncated, or any other modifications desired by the user.

Once the user has completed any desired modifications the group or table may be saved and used to construct search queries from the groups of keywords with software compatible operators for use with an electronic database or search engine. With a table containing keywords, the groups of related terms in the table may be input into the search query field of an electronic database or search engine manually by the user. In the alternative, the table may be linked to an electronic database or search engine through electronic communication and input the groups of related terms in the search query field of an electronic database or search engine without any additional action by the user. The user may add keywords to the table at any time by recursively performing steps 102-106 of the method 100 as described above, for example, while the user is conducting a search of an electronic database and discovers a new keyword.

### 3. System

The exemplary embodiment of the method described may be implemented in an electronic system which may include, but is not limited to, a computing device, a personal computer, a laptop, a network of computing devices or systems, personal digital assistants, mobile telephones, etc. Also, a computer readable medium may store various components, such as, instructions containing the steps of the method to be executed by the processing unit of an electronic system, sources of keywords, or content of an electronic database. A user may interact with the system through a user interface associated with an electronic system, which may include but is not limited to, a graphical display, a keyboard, a keypad, a computer mouse, a touch screen, a monitor, a screen, voice recognition equipment, etc. Electronic communication between components of the system may be achieved through any known communication systems, including but not limited to, radio frequency, internet, intranet, telephonic communication lines, fiber optic lines, dedicated communication lines, wireless data transmission systems, two-way cable systems, customized computer networks, interactive kiosk networks, etc.

Although specific embodiments of the present invention have been illustrated and described herein, it will be appreciated by those of ordinary skill in the art that any arrangement which is calculated to achieve the same purpose may be substituted for the specific embodiments shown. In addition, although the above invention is demonstrated as a software based implementation, the invention could be implemented as software, hardware, or any combination foreseeable to one of ordinary skill in the art. This application is intended to cover any adaptations or variations within the spirit of the invention.

What is claimed is:

1) A method of generating a keyword table for searching an electronic database, comprising the steps of:
a) Generating a table having a plurality of columns;
b) Inputting at least one keyword in one of said columns of said table;
c) Outputting, in an automated manner from a source, at least one suggestion of a related term for said at least one keyword input;
d) Selecting at least one of said suggestions of said related term to be included in said table; and
e) Populating said table in an automated manner based on said selection of said related term.

2) The method of claim 1, further including the step of modifying said at least one keyword in said populated table.

3) The method of claim 1, wherein said step of generating said table further includes the steps of:
a) Creating a plurality of columns designated for keywords; and
b) Creating at least one column designated for keywords with software compatible operators.

4) The method of claim 3, further including the step of designating one of said plurality of columns for first tier keywords.

5) The method of claim 3, further including the step of designating one of said plurality of columns for second tier keywords.

6) The method of claim 3, further including the step of designating one of said plurality of columns for acronyms.

7) The method of claim 3, further including the step of designating one of said plurality of columns for case sensitive keywords.

8) The method of claim 3, further including the step of selecting a database from a group of known databases to be associated with said at least one column designated for keywords with software compatible operators.

9) The method of claim 3, further including the step of selecting at least one of said software compatible operators from the group consisting of operators indicating the number of characters to follow a term, the case sensitive nature of the term, the proximity of terms to other terms, the part of speech of the term, the part of speech of the term, all terms must be present, and only one term must be present.

10) The method of claim 1, further including the step of selecting said source from the group consisting of a commercially available dictionary, a commercially available thesaurus, a database of previously executed search queries stored in a memory, a database of previous keyword tables stored in a memory, and a database of art-specific keywords developed by experts in a particular technology field.

11) The method of claim 1, further including the step of selecting at least one of said suggestion of a related term from the group consisting of common language synonyms, art specific synonyms, common misspellings, foreign spellings, acronyms, acronym expansions, and abbreviations.

12) The method of claim 1, further including the step of selecting said suggestion of a related term by utilizing at least one from the group consisting of a computer mouse, a keyboard, a keypad, a voice recognition device and a touch screen.

13) The method of claim 1, further including the step of populating said table with a combination of said terms located in said columns of said table and said software compatible operators.

14) The method of claim 1, wherein said automated manner requires no additional action by a user.

15) The method of claim 1, wherein said steps of d) Selecting at least one of said suggestions of said related term to be included in said table; and e) Populating said table in an automated manner based on said selection of said related term; may be performed in any order.

16) The method of claim 1, further including the step of recursively executing said method to generate said table with a plurality of rows containing said at least one keyword in each row.

17) A method for generating a keyword set, comprising the steps of:
a) Generating a set having a plurality of discrete sections;
b) Inputting at least one keyword in one of said discrete sections of said set;
c) Outputting, in an automated manner from a source, at least one suggestion of a related term for said at least one keyword input;
d) Selecting at least one of said suggestions of said related term to be included in said set; and
e) Displaying said at least one keyword in said set in a categorized manner based on said selection of said related term.

18) The method of claim 17, further including the step of modifying said at least one keyword in said set.

19) The method of claim 17, further including the step of creating at least one discrete section for keywords with software compatible operators.

20) The method of claim 17, further including the step of recursively executing said method to generate said set with a plurality groups containing said at least one keyword.

21) A system for searching electronically formatted information, comprising:
a) At least one electronic database;
b) A computing system having a processor unit for processing search queries and a display;
c) A user interface for searching said at least one electronic database through search queries and displaying results on said computing system display;
d) A source of keywords and associated meanings stored in a computer readable medium; and
e) A keyword table capable of being displayed on said computing system display.

22) The system of claim 21, wherein said keyword table is populated in an automated manner with at least one suggestion of a keyword from said source.

23) The system of claim 21, wherein said keyword table includes at least one section designated for at least one keyword and software compatible operators.

24) The system of claim 23, wherein said user interface for searching said at least one electronic database, and said at least one section designated for at least one keyword and software compatible operators are linked through electronic communication.
